(19) United States
(12) Patent Application Publication
(10) Pub. No.: US 2026/0147184 A1
(43) Pub. Date: May 28, 2026

(54) OPTICAL IMAGING LENS

(71) Applicant: Genius Electronic Optical (Xiamen) Co., Ltd., Xiamen (CN)

(72) Inventors: Wensen Chen, Xiamen (CN); Linhua Wu, Xiamen (CN); Weiwei Fu, Xiamen (CN)

(73) Assignee: Genius Electronic Optical (Xiamen) Co., Ltd., Xiamen (CN)

(21) Appl. No.: 19/012,905

(22) Filed: Jan. 8, 2025

(30) Foreign Application Priority Data
Nov. 22, 2024 (CN) 202411686627.7

(51) Int. Cl. G02B 13/00; G02B 7/02

(52) U.S. Cl. CPC G02B 13/0045; G02B 7/021; G02B 7/025; G02B 7/026

(57) ABSTRACT

The invention provides an optical imaging lens, which sequentially comprises a first lens group and a second lens group along an optical axis from an object side to an image side. A barrel has a front end close to the object side and a rear end close to the image side, and the rear end has an adhesive surface facing the image side. The first lens group is arranged and fixed in the barrel, and the second lens group has a mounting portion fixed on the adhesive surface of the barrel through a glue. The optical imaging lens satisfies the following conditions: 0.95≤ODG2/ODB≤1.05, and 18≤ODG2/Wba≤58, wherein ODG2 is the maximum outer diameter of the second lens group, ODB is the maximum outer diameter of the barrel, and Wba is the maximum width of the adhesive surface at the rear end in a radial direction.

### BACKGROUND OF THE INVENTION

### 1. Field of the Invention

The invention relates to the optical field, in particular to an improved optical lens design structure, which has a smaller barrel and a second lens group at least partially exposed outside the barrel, which is beneficial to reducing the size of an optical imaging lens.

### 2. Description of the Prior Art

The specifications of portable electronic devices are changing with each passing day, and its key component: optical imaging lens is also developing more diversified. For the main lens element of portable electronic devices, not only larger aperture and shorter system length are required, but also higher pixels and higher resolution are sought. However, high pixel and high resolution imply that it is necessary to increase the number and outer diameter of lens elements to improve image height and imaging quality. In addition, increasing the number and outer diameter of the lens will increase the volume and weight of the lens, which requires a voice coil motor (VCM) with greater driving force to focus the optical imaging lens, and the VCM with greater driving force also means that the VCM must have a larger volume to generate greater driving force. Therefore, the installation space of the optical imaging lens is not linearly increased.

The more difficult point is that portable electronic devices also pursue thinness, so the internal installation space is limited. Therefore, how to improve the image height and imaging quality while maintaining or even reducing the outer diameter of the optical imaging lens is a contradictory problem that needs to be solved.

### SUMMARY OF THE INVENTION

The invention provides an optical imaging lens, from an object side to an image side along an optical axis, which sequentially comprises a first lens group and a second lens group. A barrel has a front end close to the object side and a rear end close to the image side, and the rear end has an adhesive surface facing the image side. The first lens group is arranged and fixed in the barrel, and the second lens group has a mounting portion fixed on the adhesive surface of the barrel through a glue. The optical imaging lens satisfies the following conditions: 0.95≤ODG2/ODB≤1.05, and 18≤ODG2/Wba≤58, where ODG2 is the maximum outer diameter of the second lens group, ODB is the maximum outer diameter of the barrel, and Wba is the maximum width of the adhesive surface at the rear end in a radial direction.

In some embodiments of the present invention, the optical imaging lens also satisfies the following conditions: 1.05≤2ImgH/ODG2≤1.25, where ImgH is the image height of the optical imaging lens.

In some embodiments of the present invention, the optical imaging lens also satisfies the following conditions: 0.32 mm≤Wmi≤0.48 mm, and 18≤ODG2/Wmi≤45, wherein the mounting portion of the second lens group has an image-side surface, and Wmi is the maximum width of the image-side surface of the mounting portion of the second lens group in the radial direction.

In some embodiments of the present invention, the optical imaging lens also satisfies the following conditions: 1.07≤ODG2/ODG1≤1.22, wherein the first lens group comprises a plurality of lens elements, wherein the lens element with the maximum outer diameter is the last lens counted from the object side to the image side, and ODG1 is the maximum outer diameter of the first lens group.

In some embodiments of the present invention, the optical imaging lens also satisfies the following conditions: 16≤ODG2/W2g≤58, where W2g is the maximum width of an adhesion part between the mounting portion of the second lens group and the glue in the radial direction.

In some embodiments of the present invention, the optical imaging lens also satisfies the following conditions: 10.7≤ODG2/Wmo≤15.7, where Wmo is the maximum width of an object-side surface of the mounting portion of the second lens group in the radial direction.

In some embodiments of the present invention, the optical imaging lens also satisfies the following conditions: 8.3≤TG1/TG2≤10.5, where TG1 is the thickness of the first lens group along the optical axis, and TG2 is the thickness of the second lens group along the optical axis.

In some embodiments of the present invention, the optical imaging lens also satisfies the following conditions: 1.02≤ODG2/IDa≤1.14, where IDa is the minimum inner diameter of the adhesive surface.

In some embodiments of the present invention, the optical imaging lens also satisfies the following conditions: 18≤ODG2/Wba≤32.

In some embodiments of the present invention, the optical imaging lens also satisfies the following conditions: 32≤ODG2/Wba≤60, wherein the optical imaging lens has a fixing ring arranged between the first lens group and the second lens group, and the mounting portion of the second lens group has a protruding mesa, and the protruding mesa is embedded with the rear end of the barrel.

In some embodiments of the present invention, the optical imaging lens also satisfies the following conditions: Dn≤0.05 mm, and 6 degrees ≤Nn×α≤240 degrees, wherein the periphery of the protruding mesa has a plurality of recesses extending to the optical axis, Dn is the depth of the recesses, Nn is the number of recesses, and a is the angle of the recesses.

The invention is characterized in that in some embodiments of the invention, because all lens elements are arranged in the barrel, the size of the barrel needs to be designed to be larger than the size of the lens group. When the number of lens elements increases, the size of the barrel and other peripheral components such as voice coil motors will also increase, which is not conducive to miniaturization of optical imaging lenses. In order to solve the above problems, in other embodiments of the present invention, the lens element closest to the image side (that is, the second lens group) is at least partially arranged outside the barrel, and then the second lens group is fixed with the barrel in an adhesive or embedded manner, that is, the size of the barrel does not need to be designed to be larger than the size of the second lens group, but the barrel can be designed to have the same or close outer diameter as the outer diameter of the second lens group. In this way, the size of the barrel of the optical imaging lens can be reduced, and at the same time, the size of the overall optical imaging lens can be reduced, which is beneficial to miniaturization of components.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic sectional view of an optical imaging lens according to a first embodiment of the present invention.

FIG. 2 is a schematic sectional view of an optical imaging lens according to a second embodiment of the present invention.

FIG. 3 is an enlarged schematic view of the sectional structure of the optical imaging lens according to the second embodiment of the present invention.

FIG. 4 is a schematic sectional view of an optical imaging lens according to a third embodiment of the present invention.

FIG. 5 is a schematic sectional view of an optical imaging lens according to a fourth embodiment of the present invention.

FIG. 6 is a schematic sectional view of an optical imaging lens according to a fifth embodiment of the present invention.

FIG. 7 is an enlarged schematic view of the cross-sectional structure of the optical imaging lens according to the fifth embodiment of the present invention.

FIG. 8 shows a top view of the second lens group of the optical imaging lens according to the fifth embodiment of the present invention, and the corresponding sectional schematic diagram.

FIG. 9 is a schematic sectional view of an optical imaging lens according to a sixth embodiment of the present invention.

FIG. 10 is a schematic sectional view of an optical imaging lens according to a seventh embodiment of the present invention.

### DETAILED DESCRIPTION

To provide a better understanding of the present invention to users skilled in the technology of the present invention, preferred embodiments are detailed as follows. The preferred embodiments of the present invention are illustrated in the accompanying drawings with numbered elements to clarify the contents and the effects to be achieved.

Please note that the figures are only for illustration and the figures may not be to scale. The scale may be further modified according to different design considerations. When referring to the words “up” or “down” that describe the relationship between components in the text, it is well known in the art and should be clearly understood that these words refer to relative positions that can be inverted to obtain a similar structure, and these structures should therefore not be precluded from the scope of the claims in the present invention.

### First Embodiment

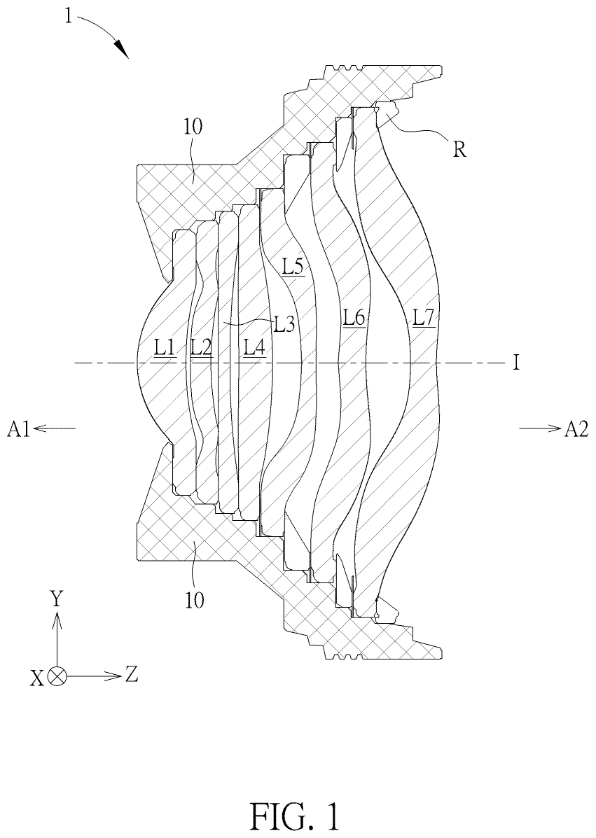

As shown in FIG. 1, FIG. 1 is a schematic sectional view of an optical imaging lens according to a first embodiment of the present invention. As shown in FIG. 1, an optical imaging lens 1 comprises a plurality of lens elements arranged in a barrel 10. Take this embodiment as an example, in which from an object side A1 to an image side A2 along the direction of the optical axis I, a plurality of lens groups sequentially include a first lens element L1, a second lens element L2, a third lens element L3, a fourth lens element L4, a fifth lens element L5, a sixth lens element L6 and a seventh lens element L7. That is, the optical imaging lens in this embodiment includes a total of seven lens elements arranged in the barrel 10. In addition, the optical imaging lens 1 in this embodiment also includes a fixing ring R, and the function of the fixing ring R is to fix the lens in the barrel 10 to avoid lens displacement.

The optical axis I is the optical axis of the entire optical imaging lens 1, so the optical axis of each lens element and the optical axis of the optical imaging lens 1 are the same. When the imaging ray (not shown) emitted by the object (not shown) from the object side A1 enters the optical imaging lens 1 of the present invention, it will pass through the first lens element L1 to the seventh lens element L7 in sequence, and will be focused on the imaging plane (not shown) on the image side A2 to form a clear image.

In addition, although the optical imaging lens 1 in this embodiment includes seven lens elements, it can be understood that the present invention can also be applied to optical imaging lenses with different lens numbers, which will be described here.

In this embodiment, all seven lens elements of the optical imaging lens 1 are arranged in the barrel 10, that is to say, the barrel 10 needs to have a large enough space to accommodate the seven lens elements in cross section. However, with the development of optical technology, optical imaging lenses with more lens elements may be gradually developed and applied to electronic products on the market. When the number of lens elements of optical imaging lens increases, not only a larger barrel is needed to accommodate the lens elements, but also the dimensions of other peripheral components outside the optical imaging lens, such as voice coil motor (VCM) for driving the optical imaging lens, will also increase. According to the applicant's experimental observation, when the number of lens elements of the optical imaging lens is more than seven, the total volume of each element will be significantly increased in a nonlinear proportion, which is not conducive to the miniaturization of the optical imaging lens. Taking this embodiment as an example, all seven lens elements are arranged in the barrel 10, and the maximum outer diameter of the barrel is about 12.800 mm.

Therefore, in order to solve the problem that the size of the above barrel is too large, in other embodiments of the present invention, other optical imaging lenses with different structures are proposed, especially for adjusting the configuration of the barrel and the lens element closest to the image side A2. It is worth noting that in the following embodiments, the relationship between the barrel 10 and the lens element closest to the image side A2 will be emphasized. Therefore, except for the barrel 10 and the lens element closest to the image side A2, the other lens elements arranged inside the barrel 10 will be omitted and not drawn. For example, when the optical imaging lens includes seven lens elements, the other six lens elements L1-L6 except the seventh lens element L7 will be omitted and not drawn. However, it should be clear to those skilled in the art that, in various embodiments of the present invention, the barrel 10 still comprises a plurality of lens elements, and the parameters such as the configuration and surface shape of each lens can make the imaging ray clearly image on the imaging plane after passing through the optical imaging lens.

The following description will detail the different embodiments of the present invention. To simplify the description, the following description will detail the dissimilarities among the different embodiments and the identical features will not be redundantly described. In order to compare the differences between the embodiments easily, the identical components in each of the following embodiments are marked with identical symbols.

### Second Embodiment

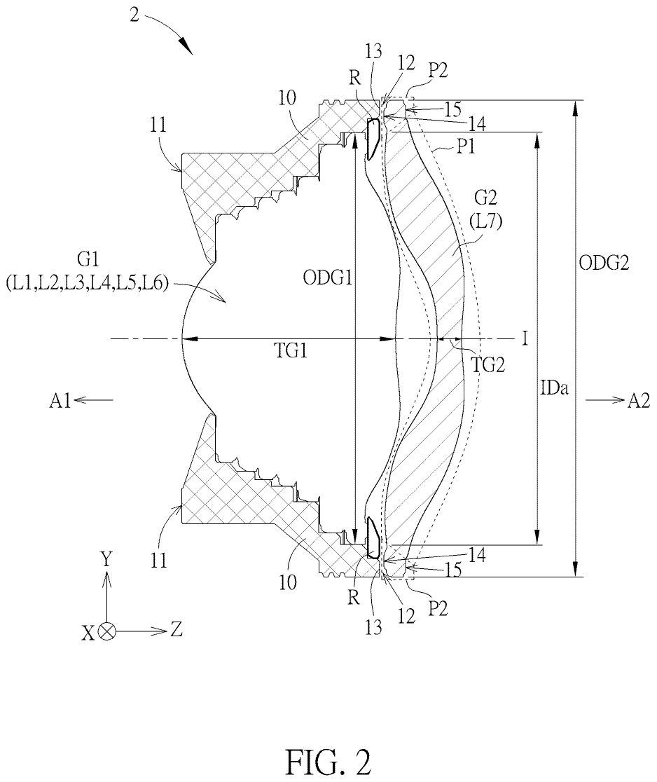

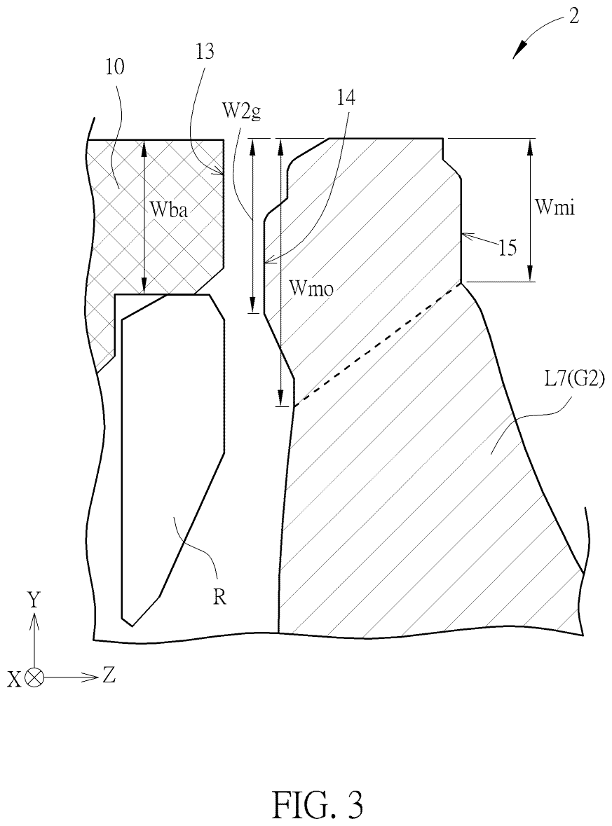

Please refer to FIG. 2 and FIG. 3. FIG. 2 shows a schematic cross-sectional structure of an optical imaging lens according to a second embodiment of the present invention, and FIG. 3 shows an enlarged schematic cross-sectional structure of the optical imaging lens according to a second embodiment of the present invention. As shown in FIG. 2, the optical imaging lens 2 includes a plurality of lens elements and a barrel 10. In this embodiment, the optical imaging lens 2 has seven lens elements L1-L7, in which the seventh lens element L7 closest to the image side A2 is defined as the second lens group G2, and the remaining six lens elements (L1-L6) are defined as the first lens group G1. As described above, since the main feature of the present invention is the relationship between the barrel 10 and the second lens group G2, so the lens elements of the first lens group G1 are not drawn in the drawing. However, it can be understood that the configuration and surface shape of each lens element included in the first lens group G1 and the second lens group G2 can make the imaging ray clearly image on the imaging plane after passing through the optical imaging lens under the conditions mentioned in the present invention.

This embodiment is characterized in that the first lens group G1 is arranged and fixed in the barrel 10, while the second lens group G2 is located outside and attached to the barrel 10. More specifically, the barrel 10 defines a front end 11 near the object side A1 and a rear end 12 near the image side A2, and the rear end 12 includes an adhesive surface 13 facing the image side A2. In addition, the second lens group G2 (in this embodiment, the seventh lens element L7) may include an optical effective portion P1 and a mounting portion P2, where the optical effective portion P1 is the portion that allows the imaging ray to pass through, that is, the imaging ray emitted from the object side A1 will pass through the optical effective portions of the first lens group G1 and the second lens group G2, and be focused on the imaging plane to form a clear image. Here, in order to simplify the drawing, only the optical effective portion P1 of the second lens group G2 (the seventh lens element L7) is drawn, but it can be understood that each lens element of the first lens group G1 comprises an optical effective portion for imaging ray to pass through. The mounting portion P2 of the second lens group G2 described here is a portion for combining the second lens group G2 with the barrel 10. More specifically, when the second lens group G2 is manufactured, a portion of the area closest to the edge (or farthest from the optical axis I) is used to connect the second lens group G2 with the barrel 10, and the imaging ray will not pass through the mounting portion P2. Taking this embodiment as an example, the mounting portion P2 of the second lens group G2 has an object-side surface 14 facing the object side A1 and an image-side surface 15 facing the image side A2. The adhesive surface 13 of the barrel 10 facing the image side A2 and the object-side surface 14 of the mounting portion P2 of the second lens group G2 can be attached to each other by a glue (not shown). That is to say, the second lens group G2 in this embodiment is not located in the barrel 10, but is adhered to the adhesive surface 13 of the barrel 10 by the glue. In addition, as seen from FIG. 2, the fixing ring R is located between the first lens group G1 and the second lens group G2. Specifically, the first lens group G1 is fixed in the barrel 10 by the fixing ring R, and the second lens group G2 is located outside the fixing ring R.

Next, please refer to FIG. 2 and FIG. 3. First, some important parameters in the present invention are defined as follows. First of all, the “radial direction” in the present invention refers to the direction that diverges outward from the position of the optical axis I and is perpendicular to the optical axis I. From the perspective view, the radial direction includes an infinite number of directions, but from the sectional view of FIG. 2 or FIG. 3, the optical axis I extends along the Z direction, and the radial direction is the direction perpendicular to the Z axis, that is, the radial direction is parallel to the Y axis direction.

ODG1 is defined as the maximum outer diameter of the first lens group G1, that is, as shown in FIG. 2, the first lens group G1 comprises a plurality of lens elements, one of which has the maximum outer diameter, where ODG1 is the outer diameter of this lens element with the maximum outer diameter. The so-called “outer diameter” is defined as the maximum width of the lens element in the radial direction (the Y axis direction), that is, the width from the uppermost edge to the lowermost edge of this lens element in the radial direction (the Y axis direction), or twice the width from the optical axis I to the edge of the lens element with the maximum outer diameter of the first lens group G1 in the radial direction (the Y axis direction). In this embodiment, the lens element with the maximum outer diameter in the first lens group G1 is the last lens element from the object side A1 to the image side A2, that is, in this embodiment, the first lens group G1 includes six lens elements L1 to L6, which are arranged from the object side A1 to the image side A2 in sequence, and the lens element with the maximum outer diameter is the sixth lens element L6, that is, the lens element closest to the image side A2.

ODG2 is defined as the maximum outer diameter of the second lens group G2. Since the second lens group G2 is the seventh lens element L7 in this embodiment, ODG2 is also the maximum width of the seventh lens element L7 in the radial direction, or twice the width from the optical axis I to the edge of the mounting portion P2 of the second lens group G2 in the radial direction (the Y axis direction).

ODB is defined as the maximum outer diameter of the barrel 10, that is, the maximum width of the barrel 10 in the radial direction. Wba is defined as the maximum width of the adhesive surface 13 of the rear end 12 of the barrel 10 in the radial direction. Reference can be made to the definitions marked in FIG. 2 and FIG. 3.

Wmo is the maximum width of the object-side surface 14 of the mounting portion P2 of the second lens group G2. As mentioned above, the second lens group G2 includes an optical effective portion P1 which is close to the optical axis I and allows the imaging ray to pass through, and a mounting portion P2 which is far from the optical axis I and does not allow the imaging ray to pass through. Here, Wmo is the maximum width of the object-side surface 14 of the mounting portion P2 of the second lens group G2, or Wmo is the maximum width of the object-side surface 14 along the Y direction from the upper edge of the mounting portion P2 of the second lens group G2 to the upper edge of the optical effective portion P1.

Wmi is the maximum width of the image-side surface 15 of the mounting portion P2 of the second lens group G2. As mentioned above, the second lens group G2 includes an optical effective portion P1 which is close to the optical axis I and allows the imaging ray to pass through, and a mounting portion P2 which is far from the optical axis I and does not allow the imaging ray to pass through. Here, Wmi is the maximum width of the image-side surface 15 of the mounting portion P2 of the second lens group G2, or Wmi is the maximum width of the image-side surface 15 along the Y direction from the upper edge of the mounting portion P2 of the second lens group G2 to the upper edge of the optical effective portion P1.

W2g is the maximum width of the adhesion part between the mounting portion P2 of the second lens group G2 and the glue (not shown) in the radial direction (the Y axis direction). Please refer to the enlarged schematic diagram of FIG. 3. In order to make the second lens group G2 and the adhesive surface 13 adhere to each other, glue is injected between the object-side surface 14 of the mounting portion P2 of the second lens group G2 and the adhesive surface 13 of the barrel 10. Here, W2g is the maximum width of the injected glue. More precisely, W2g is different from the above-mentioned Wmo in that Wmo is the maximum width along the Y direction from the upper edge of the mounting portion P2 of the second lens group G2 to the upper edge of the optical effective portion P1 (or the boundary where imaging ray can pass), while W2g is the maximum width along the Y direction from the upper edge of the mounting portion P2 of the second lens group G2 to the lower edge of the glue, which is usually smaller than Wmo to prevent the glue from overflowing and covering part of the optical effective portion P1.

In addition, ImgH is defined as the image height of the optical imaging lens. TG1 is defined as the thickness of the first lens group G1 along the optical axis I, that is, the maximum thickness of the first lens group G1 along the Z direction, and TG2 is defined as the thickness of the second lens group G2 along the optical axis I, that is, the maximum thickness of the second lens group G2 along the Z direction. Taking this embodiment as an example, TG1 is the thickness of the first lens group G1, or the distance from the intersection point between the object-side surface of the first lens element L1 and the optical axis I to the intersection point between the image-side surface of the sixth lens element L6 and the optical axis I along the optical axis I (or Z direction), and TG2 is the thickness of the seventh lens element L7 along the optical axis I.

IDa is defined as the smallest inner diameter of the adhesive surface 13 of the rear end 12 of the barrel 10. That is, when viewed from the cross section, twice of the width from the lower edge of the adhesive surface 13 to the optical axis I in the radial direction, or the maximum outer diameter ODB of the barrel 10 minus twice the maximum width Wba of the adhesive surface.

In this embodiment, the values of each parameter are shown in Table 1 below.

TABLE 1

| Parameter | Value (mm) |
|---|---|
| ODG1 | 9.500 |
| ODG2 | 11.000 |
| ODB | 11.000 |
| Wba | 0.436 |
| Wmi | 0.410 |
| W2g | 0.488 |
| Wmo | 0.740 |
| ImgH | 6.480 |
| TG1 | 4.925 |
| TG2 | 0.561 |
| IDa | 10.128 |

In the first embodiment above, because all the lens elements are located in the barrel 10, the maximum outer diameter (ODB) of the barrel 10 is about 12.800 mm. However, in this embodiment, because the second lens group G2 is arranged outside the barrel 10, the barrel 10 does not need to accommodate all the lens elements, and the size of the barrel 10 can be reduced accordingly. Compared with the first embodiment, the ODB of this embodiment can be reduced from 12.800 mm to 11.000 mm. So that miniaturization of component is facilitated.

### Third Embodiment

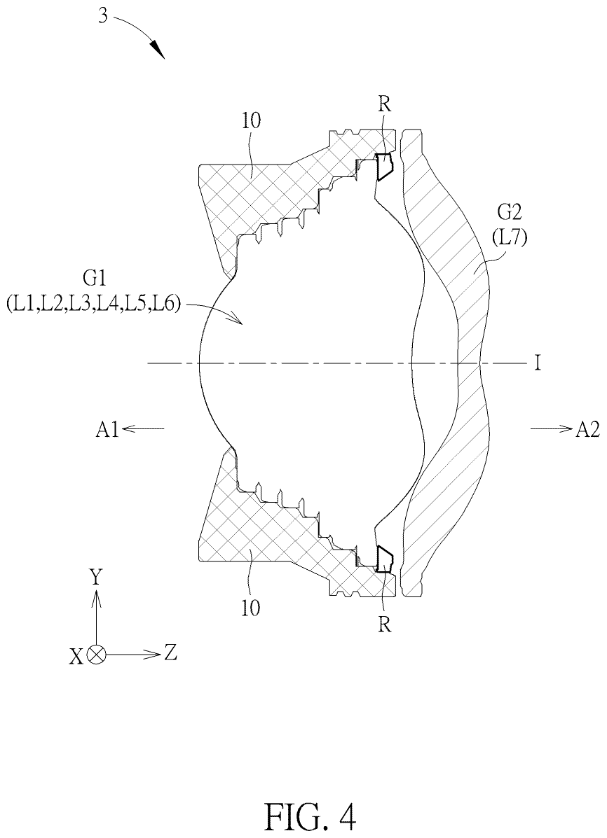

Please refer to FIG. 4, which shows a schematic cross-sectional structure of an optical imaging lens according to a third embodiment of the present invention. As shown in FIG. 4, the optical imaging lens 3 includes a plurality of lens elements and a barrel 10. In this embodiment, the optical imaging lens 3 has seven lens elements, of which the seventh lens element L7 closest to the image side A2 is defined as the second lens group G2, and the remaining six lens elements are defined as the first lens group G1. In order to simplify the drawing, the lens elements of the first lens group G1 are not drawn in the drawing. However, it can be understood that the configuration and surface shape of each lens element included in the first lens group G1 and the second lens group G2 can make the imaging ray clearly image on the imaging plane after passing through the optical imaging lens under the conditions mentioned in the present invention.

This embodiment is different from the above-mentioned second embodiment in that the parameters such as the surface shape of each lens element are different. As shown in FIG. 4, the shapes of the lens elements included in the optical imaging lens 3 are different from those described in the second embodiment. However, like the second embodiment, the first lens group 10 is arranged and fixed in the barrel 10, while the second lens group G2 is also arranged outside the barrel 10 and adhered to the barrel 10. In this way, since the barrel 10 does not need to accommodate all the lens elements, the design size of the barrel 10 can be reduced.

It can be understood from this embodiment that the concept of the present invention can be applied to lens groups with different surface shapes, and the functions of imaging ray and reducing the volume of elements can also be achieved. For example, according to the applicant's experimental results, if all the lens group contained in this embodiment are arranged in the barrel, the measured maximum outer diameter (ODB) of the barrel is about 10.800 mm, but because the second lens group G2 is arranged outside the barrel 10 in this embodiment, the ODB can be reduced from 10.800 mm to 9.080 mm, which is beneficial to miniaturization of components. As for other parameter definitions, they are the same as those described in the second embodiment above, so they are not repeated here.

In this embodiment, the values of each parameter are shown in Table 2 below.

TABLE 2

| Parameter | Value (mm) |
|---|---|
| ODG1 | 7.9 |
| ODG2 | 9.08 |
| ODB | 9.08 |
| Wba | 0.48 |
| Wmi | 0.4532 |
| W2g | 0.5363 |
| Wmo | 0.695 |
| ImgH | 5.375 |
| TG1 | 4.1176 |
| TG2 | 0.4323 |
| IDa | 8.12 |

### Fourth Embodiment

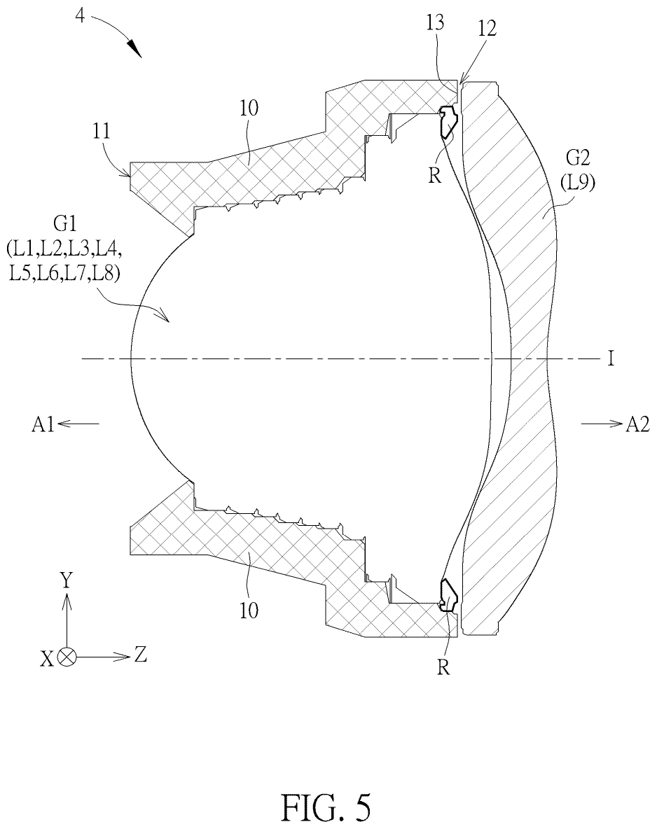

Please refer to FIG. 5, which shows a schematic cross-sectional structure of an optical imaging lens according to a fourth embodiment of the present invention. As shown in FIG. 5, the optical imaging lens 4 includes a plurality of lens elements and a barrel 10. In this embodiment, the optical imaging lens 4 has nine lens elements, of which the ninth lens element L9 closest to the image side A2 is defined as the second lens group G2, and the remaining eight lens elements (L1-L8) are defined as the first lens group G1. In order to simplify the drawing, the lens elements of the first lens group G1 are not drawn in the drawing. However, it can be understood that the configuration and surface shape of each lens element included in the first lens group G1 and the second lens group G2 can make the imaging ray clearly image on the imaging plane after passing through the optical imaging lens under the conditions mentioned in the present invention.

This embodiment is different from the above-mentioned second embodiment in that the number and surface shape of each lens element are different. As shown in FIG. 5, the shapes of the lens elements included in the optical imaging lens 4 are different from those described in the second embodiment, and this embodiment also includes more lens elements (nine lens elements in total). However, like the second embodiment, the first lens group 10 is arranged and fixed in the barrel 10, while the second lens group G2 is also arranged outside the barrel 10 and adhered to the barrel 10. In this way, since the barrel 10 does not need to accommodate all the lens elements, the design size of the barrel 10 can be reduced.

It can be understood from this embodiment that the concept of the present invention can be applied to lens groups with different surface shapes and different lens numbers, and can also achieve the functions of imaging ray and reducing the volume of elements. For example, according to the applicant's experimental results, if all the lens elements contained in this embodiment are arranged in the barrel, the measured maximum outer diameter (ODB) of the barrel is about 16.400 mm, but because the second lens group G2 is arranged outside the barrel 10 in this embodiment, the ODB can be reduced from 16.400 mm to 14.600 mm, which is beneficial to miniaturization of components. In addition, the concept of the present invention can also be applied to optical imaging lenses with different lens numbers, such as lens groups with seven, eight, nine, ten or other numbers, and it also falls within the application scope of the present invention.

It is worth noting that there are nine lens elements in this embodiment, so in the first lens group G1, the last lens element from the object side A1 to the image side A2 is the eighth lens element L8, in other words, the eighth lens element L8 may be the lens element with the maximum outer diameter in the first lens group G1. And the second lens group G2 includes the ninth lens element L9. As for other parameter definitions, they are the same as those described in the second embodiment above, so they are not repeated here.

In this embodiment, the values of each parameter are shown in Table 3 below.

TABLE 3

| Parameter | Value (mm) |
|---|---|
| ODG1 | 12.832 |
| ODG2 | 14.500 |
| ODB | 14.600 |
| Wba | 0.691 |
| Wmi | 0.340 |
| W2g | 0.807 |
| Wmo | 0.895 |
| ImgH | 8.000 |
| TG1 | 9.442 |
| TG2 | 0.935 |
| IDa | 13.217 |

### Fifth Embodiment

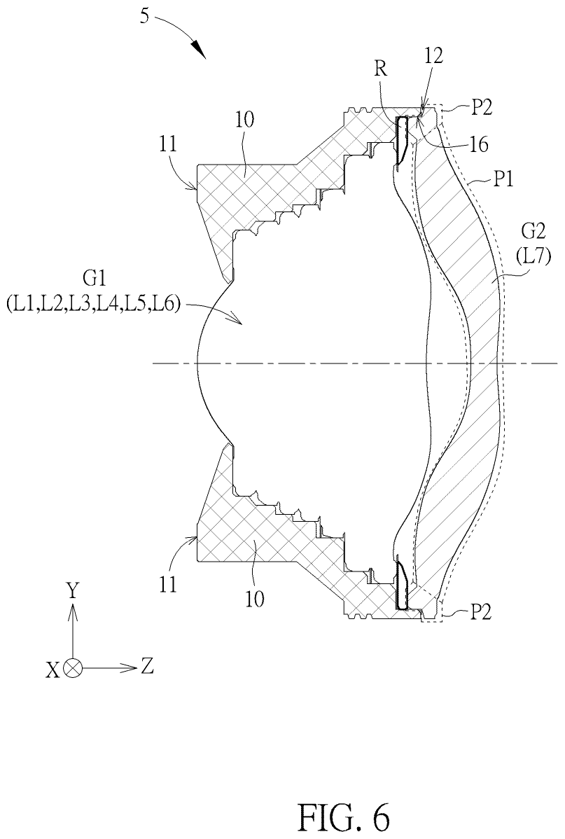

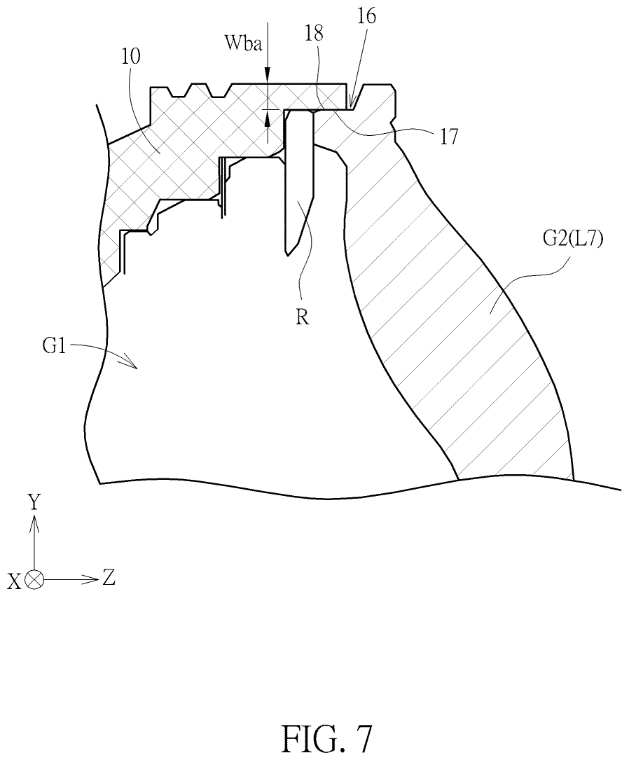

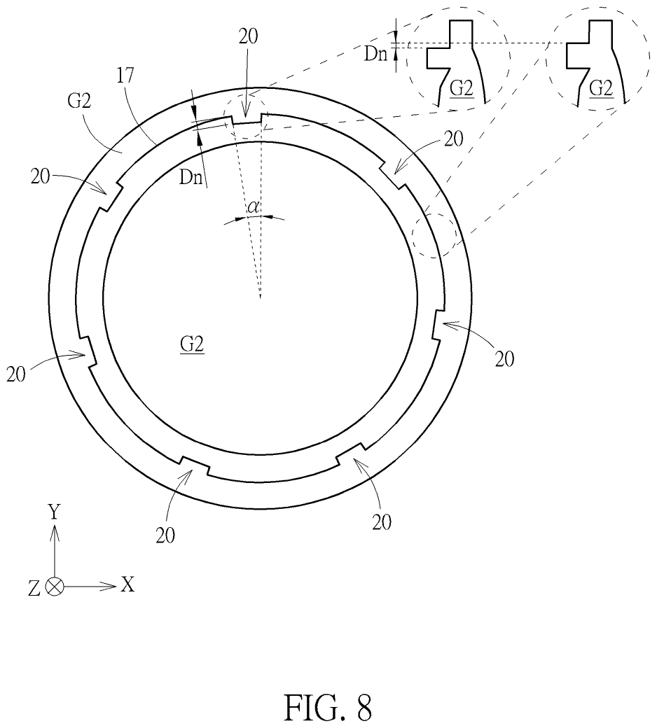

Please refer to FIG. 6, FIG. 7 and FIG. 8. FIG. 6 shows the schematic cross-sectional structure of the optical imaging lens according to the fifth embodiment of the present invention, FIG. 7 shows the partially enlarged cross-sectional structure of the optical imaging lens according to the fifth embodiment of the present invention, and FIG. 8 shows the top view of the second lens group of the optical imaging lens according to the fifth embodiment of the present invention and the corresponding schematic cross-sectional. As shown in FIG. 6, the optical imaging lens 5 includes a plurality of lens elements and a barrel 10. In this embodiment, the optical imaging lens 5 has seven lens elements, of which the seventh lens element L7 closest to the image side A2 is defined as the second lens group G2, and the remaining six lens elements L1-L6 are defined as the first lens group G1. In order to simplify the drawing, the lens elements of the first lens group G1 are not drawn in the drawing. However, it can be understood that the configuration and surface shape of each lens element included in the first lens group G1 and the second lens group G2 can make the imaging ray clearly image on the imaging plane after passing through the optical imaging lens under the conditions mentioned in the present invention.

In addition, this embodiment is different from the above-mentioned second embodiment in that in the above-mentioned second embodiment, the second lens group G2 and the adhesive surface 13 of the barrel 10 are adhered to each other by an adhesive layer (glue). However, in this embodiment, the second lens group G2 and the barrel 10 are not only adhered to each other by an adhesive layer (glue), but also connected to each other in an embedded manner. More specifically, the second lens group G2 in this embodiment has a protruding mesa 16 in cross section, and the outline of the protruding mesa 16 is generally circular in top view (as shown in FIG. 8). The function of the protruding mesa 16 in this embodiment is to provide a protruding structural part, so that the second lens group G2 can be combined with the rear end 12 of the barrel 10 by embedding. In other words, the protruding mesa 16 of the second lens group G2 has an outer ring surface 17, while the rear end 12 of the barrel 10 has an inner ring surface 18. When the second lens group G2 and the barrel 10 are embedded with each other, the outer ring surface 17 of the protruding mesa 16 can contact with the inner ring surface 18 of the rear end 12 of the barrel 10. By the embedded design, the assembly procedure and time of 5-axis alignment can be omitted. In addition, in this embodiment, except for being fixed in a mutually embedded manner, the adhesive surface 13 of the barrel 10 facing the image side A2 and the object-side surface 14 of the mounting portion P2 of the second lens group G2 can be selectively attached by an additional glue (not shown) to further enhance the bonding strength.

As shown in FIG. 8, the protruding mesa 16 of the second lens group G2 has a circular outer ring surface 17. Besides, in some embodiments, the outer ring surface 17 of the protruding mesa 16 also comprises a plurality of recesses 20 extending in the direction of the optical axis I. According to the two cross-sectional structures corresponding to FIG. 8, the cross-sectional structure at the recess 20 still has the protruding mesa 16, but its height is lower than that of other protruding mesas 16 at other non-recesses 20. Here, the height difference between the two protruding mesas can be defined as Dn, and Dn can also represent the depth of the recess 20. In addition, as shown in FIG. 8, Nn is defined here as the total number of recesses 20, and a is the angle of each recess 20 from the top view.

The purpose of forming the recess 20 here is that after the second lens group G2 and the rear end 12 of the barrel 10 are embedded with each other, the manufacturer can inject glue between the second lens group G2 and the rear end 12 of the barrel 10 to further improve the attaching strength. When the glue is injected, the glue can flow along the recess 20 to the inner ring surface 18 of the rear end 12 of the barrel 10. Therefore, the depth, number and angle of the recesses 20 will also affect the total amount of glue injected. The recess depth Dn, the total number of recesses Nn and the recess angle α of several different embodiments of the present invention are listed in Table 4 below. It should be noted that the values listed in Table 4 are only examples of some embodiments of the present invention, but the recess parameters of the present invention are not limited to this.

TABLE 4

| | Dn(mm) | Nn | α(degrees) |
|---|---|---|---|
| Embodiment A | 0.05 | 9 | 20 |
| Embodiment B | 0.02 | 12 | 10 |
| Embodiment C | 0.002 | 3 | 2 |
| Embodiment D | 0.05 | 12 | 20 |

In addition to the above features, other parameters of the present invention can be defined with reference to the above-mentioned second embodiment, so they are not repeated here. In this embodiment, the values of each parameter are shown in Table 5 below.

TABLE 5

| Parameter | Value (mm) |
|---|---|
| ODG1 | 9.500 |
| ODG2 | 11.000 |
| ODB | 11.000 |
| Wba | 0.200 |
| Wmi | 0.410 |
| W2g | 0.200 |
| Wmo | 0.740 |
| ImgH | 6.480 |
| TG1 | 4.925 |
| TG2 | 0.561 |
| IDa | 10.600 |

### Sixth Embodiment

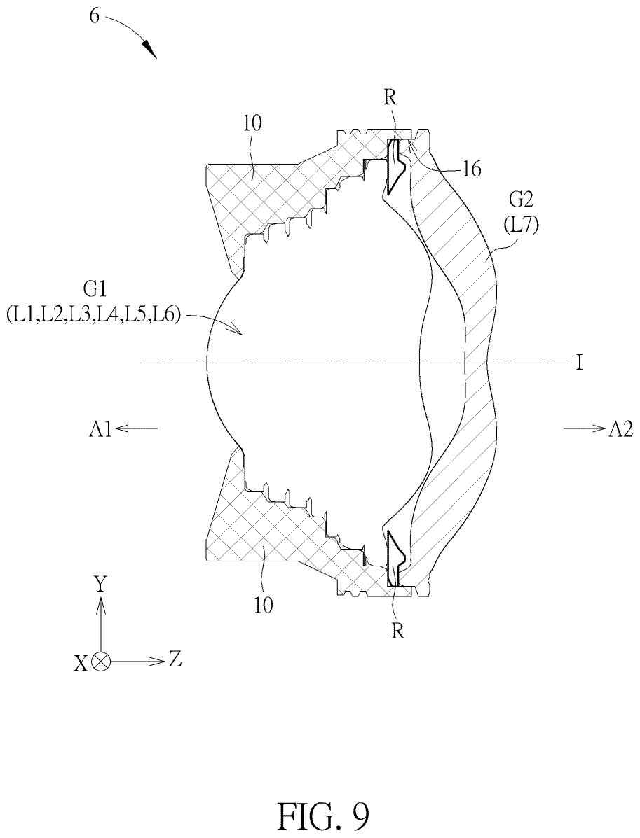

Please refer to FIG. 9, which shows a schematic cross-sectional structure of an optical imaging lens according to a sixth embodiment of the present invention. As shown in FIG. 9, the optical imaging lens 6 includes a plurality of lens elements and a barrel 10. In this embodiment, the optical imaging lens 6 has seven lens elements, of which the seventh lens element L7 closest to the image side A2 is defined as the second lens group G2, and the remaining six lens elements are defined as the first lens group G1. In order to simplify the drawing, the lens elements of the first lens group G1 are not drawn in the drawing. However, it can be understood that the configuration and surface shape of each lens element included in the first lens group G1 and the second lens group G2 can make the imaging ray clearly image on the imaging plane after passing through the optical imaging lens under the conditions mentioned in the present invention.

This embodiment is different from the above-mentioned fifth embodiment in that the parameters such as the surface shape of each lens element are different. As shown in FIG. 9, the shapes of the lens elements included in the optical imaging lens 6 are different from those described in the second embodiment. However, like the fifth embodiment, the first lens group 10 is arranged and fixed in the barrel 10, while the second lens group G2 is also arranged outside the barrel 10. The second lens group G2 has a protruding mesa 16 and is embedded with the rear end 12 of the barrel 10. In this way, since the barrel 10 does not need to accommodate all the lens elements, the design size of the barrel 10 can be reduced.

It can be understood from this embodiment that the concept of the present invention can be applied to lens groups with different surface shapes, and the functions of imaging ray and reducing the volume of elements can also be achieved. As for other parameter definitions, they are the same as those described in the above-mentioned fifth embodiment, so they are not repeated here.

In this embodiment, the values of each parameter are shown in Table 6 below.

TABLE 6

| Parameter | Value (mm) |
|---|---|
| ODG1 | 7.9 |
| ODG2 | 9.08 |
| ODB | 9.08 |
| Wba | 0.2 |
| Wmi | 0.4585 |
| W2g | 0.2 |
| Wmo | 0.695 |
| ImgH | 5.375 |
| TG1 | 4.1176 |
| TG2 | 0.4323 |
| IDa | 8.68 |

### Seventh Embodiment

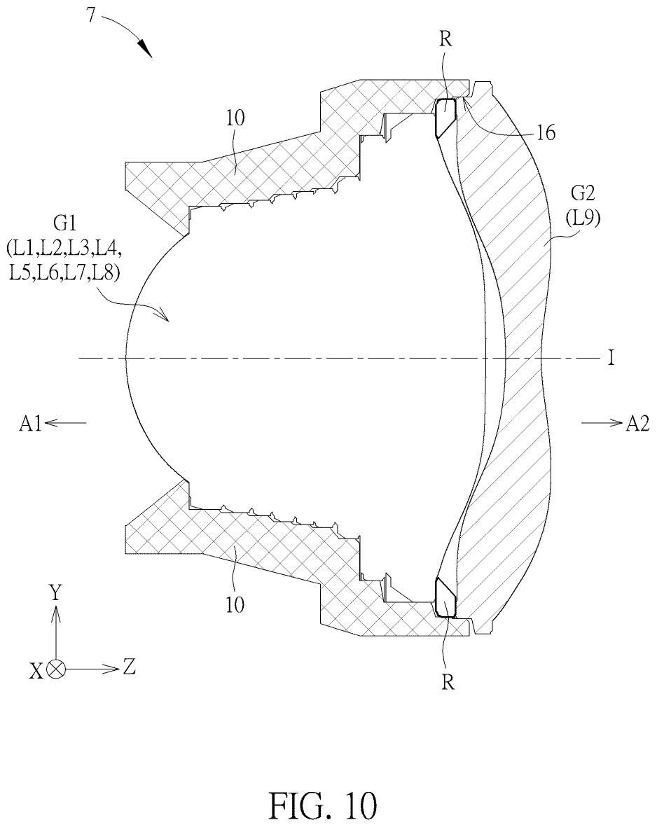

Please refer to FIG. 10, which shows a schematic cross-sectional structure of an optical imaging lens according to a seventh embodiment of the present invention. As shown in FIG. 10, the optical imaging lens 7 includes a plurality of lens elements and a barrel 10. In this embodiment, the optical imaging lens 7 has nine lens elements, of which the ninth lens element L9 closest to the image side A2 is defined as the second lens group G2, and the remaining eight lens elements L1-L8 are defined as the first lens group G1. In order to simplify the drawing, the lens elements of the first lens group G1 are not drawn in the drawing. However, it can be understood that the configuration and surface shape of each lens element included in the first lens group G1 and the second lens group G2 can make the imaging ray clearly image on the imaging plane after passing through the optical imaging lens under the conditions mentioned in the present invention.

This embodiment is different from the above-mentioned fifth embodiment in that the number and surface shape of each lens element are different. As shown in FIG. 10, the shapes of the lens elements included in the optical imaging lens 7 are different from those described in the fifth embodiment, and this embodiment also includes more lens elements (nine lens elements in total). However, like the fifth embodiment, the first lens group 10 is arranged and fixed in the barrel 10, while the second lens group G2 is also arranged outside the barrel 10. The second lens group G2 has a protruding mesa 16 and is embedded with the rear end 12 of the barrel 10. In this way, since the barrel 10 does not need to accommodate all the lens elements, the design size of the barrel 10 can be reduced.

It can be understood from this embodiment that the concept of the present invention can be applied to lens groups with different surface shapes and different lens numbers, and can also achieve the functions of imaging ray and reducing the volume of elements. In addition, the concept of the present invention can also be applied to optical imaging lenses with different lens numbers, such as lens groups with seven, eight, nine, ten or other numbers, and it also falls within the application scope of the present invention.

It is worth noting that there are nine lens elements in this embodiment, so in the first lens group G1, the last lens element from the object side A1 to the image side is the eighth lens element L8, in other words, the eighth lens element L8 may be the lens element with the maximum outer diameter in the first lens group G1. And the second lens group G2 includes a ninth lens element L9. As for other parameter definitions, they are the same as those described in the second embodiment above, so they are not repeated here.

In this embodiment, the values of each parameter are shown in Table 7 below.

TABLE 7

| Parameter | Value (mm) |
|---|---|
| ODG1 | 12.832 |
| ODG2 | 14.500 |
| ODB | 14.600 |
| Wba | 0.450 |
| Wmi | 0.340 |
| W2g | 0.400 |
| Wmo | 0.895 |
| ImgH | 8.000 |
| TG1 | 9.442 |
| TG2 | 0.935 |
| IDa | 13.700 |

In various embodiments of the present invention, the following conditions are also satisfied, and corresponding advantages can be brought as follows.
1. The optical imaging lens of the present invention is sequentially divided into a first lens group G1 and a second lens group from the object side A1 to the image side A2. The first lens group G1 is arranged and fixed in the barrel 10, and the second lens group G2 is at least partially exposed outside the barrel 10, and the mounting portion P2 of the second lens group G2 fixes the adhesive surface 13 of the rear end 12 of the barrel 10 via a glue (not shown) or/and by embedding. Since the barrel 10 does not need to completely accommodate the second lens group G2, it is beneficial to reduce the volume of the barrel 10 to reduce its outer diameter.
2. When the optical imaging lens satisfies the conditions of 0.95≤ODG2/ODB≤1.05 and 18≤ODG2/Wba≤58, it is beneficial to control the maximum outer diameter ODG2 of the second lens group G2, the maximum outer diameter ODB of the lens barrel 10 and the area of the adhesive surface 13 on the premise of avoiding insufficient thickness of the barrel 10 or too small area of the adhesive surface 13, so as to reduce the maximum outer diameter, volume and weight of the optical imaging lens, so that the module factory can design a smaller voice coil motor to focus the optical imaging lens.
3. The optical imaging lens of the present invention preferably satisfies the condition of 1.05≤2ImgH/ODG2≤1.25. When the above condition is satisfied, it is beneficial to the configuration of the barrel of the optical imaging lens, and the outer diameter of the optical imaging lens element with the full image height of 12.96 mm can be reduced to less than 11 mm.
4. The optical imaging lens of the present invention preferably satisfies the conditions of 0.32 mm≤Wmi≤0.48 mm and 18≤ODG2/Wmi≤45. When the above conditions are satisfied, it is beneficial for the five-axis optical quality alignment equipment to absorb the mounting portion P2 of the second lens group G2 to focus.
5. The optical imaging lens of the present invention preferably satisfies the condition of 1.07≤ODG2/ODG1≤1.22, wherein the lens element with the maximum outer diameter in the first lens group G1 is the last lens counted from the object side A1 to the image side A2. When the above condition is satisfied, making the last lens of the first lens group G1 and the outer diameter of the second lens group G2 have an appropriate proportion, and making the imaging ray refract at these two lens elements is beneficial to increase the half field of view (HFOV) angle.
6. The optical imaging lens of the present invention preferably satisfies the condition of 16≤ODG2/W2g≤58. When the above condition is satisfied, it is beneficial to avoid insufficient adhesive area caused by too large ratio of ODG2/W2g, or too small ratio of ODG2/W2g cannot effectively reduce the lens outer diameter, and the better range is 16≤ODG2/W2g.
7. The optical imaging lens of the present invention preferably satisfies the condition of 10.7≤ODG2/Wmo≤15.7. When the above condition is satisfied, it is beneficial to avoid the glue easily overflowing to the optical effective portion P1 of the lens element when the ratio is too large, or the outer diameter of the optical imaging lens cannot be effectively reduced when the ratio is too small.
8. The optical imaging lens of the present invention preferably satisfies the condition of 8.3≤TG1/TG2≤10.5. When the above condition is satisfied, it is beneficial to control the thickness of the first lens group G1 and the thickness of the second lens group G2 within a suitable range to reduce the outer diameter of the optical imaging lens.
9. The optical imaging lens of the present invention preferably satisfies the condition of 1.02≤ODG2/IDa≤1.14. When the above condition is satisfied, it is beneficial to avoid that the ratio is too large to reduce the outer diameter of the optical imaging lens, and also to avoid that the ratio is too small to effectively adhere and fix the second lens group G2 to the barrel 10.
10. The optical imaging lens of the present invention preferably satisfies the condition of 18≤ODG2/Wba≤32. When the above condition is satisfied, it is beneficial to align and fix the equipment aligned by five-axis optical quality, and it is also beneficial for the optical imaging lens pass the on-going reliability test (ORT).
11. The optical imaging lens of the present invention preferably satisfies the condition of 18≤ODG2/Wba≤32. When the above condition is satisfied, it is beneficial to align and fix the equipment aligned by five-axis optical quality, and it is also beneficial for the optical imaging lens to pass the on-going reliability test (ORT), and the better range is 18≤ODG2/Wba≤27.
12. The optical imaging lens of the present invention preferably satisfies the condition of 32≤ODG2/Wba≤60. When the above condition is satisfied, the optical imaging lens has a fixing ring R arranged between the first lens group G1 and the second lens group G2, which is beneficial to reducing flare. The mounting portion P2 of the second lens group G2 has an embedded structure with the rear end 12 of the barrel 10, which is beneficial to positioning and assembly to shorten the assembly time.
13. The optical imaging lens of the present invention preferably satisfies the conditions of Dn≤0.05 mm, 6 degrees≤Nnxa≤240 degrees. When the above conditions are satisfied, it is beneficial for the glue to flow between the second lens group G2 and the barrel 10 through the recess 20, so as to increase the fixing of the adhesive area. In addition, by increasing the adhesive area, the lens is beneficial to the continuous reliability verification of the lens.

Based on the above description and drawings, the characteristic of the present invention is that in some embodiments of the present invention (for example, the embodiment of FIG. 1), because all the lens elements are arranged in the barrel, the size of the barrel needs to be designed to be larger than the lens group. When the number of lens elements increases, the size of the barrel and other peripheral components such as voice coil motors will also increase, which is not conducive to the miniaturization of optical imaging lenses. In order to solve the above problems, in other embodiments of the present invention (for example, the embodiments of FIGS. 2 to 7), the lens element closest to the image side (that is, the second lens group) is at least partially arranged outside the barrel, and then the second lens group is fixed to the barrel in an adhesive or embedded manner, that is, the size of the barrel does not need to be designed to be larger than the size of the second lens group. Instead, the barrel can be designed to have the same or close outer diameter as the second lens group, so that the size of the barrel of the optical imaging lens can be reduced, and at the same time, the size of the overall optical imaging lens can be reduced, which is beneficial to miniaturization of components.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical imaging lens, in order from an object side to an image side along an optical axis comprising:
a first lens group and a second lens group;
a barrel has a front end close to the object side and a rear end close to the image side, and the rear end has an adhesive surface facing the image side, and the first lens group is arranged and fixed in the barrel;
the second lens group has a mounting portion, wherein the mounting portion of the second lens group is fixed on the adhesive surface of the barrel through a glue;
wherein the optical imaging lens satisfies the following conditions: 0.95≤ODG2/ODB≤1.05, and 18≤ODG2/Wba≤58, where ODG2 is the maximum outer diameter of the second lens group, ODB is the maximum outer diameter of the barrel, and Wba is the maximum width of the adhesive surface at the rear end in a radial direction.

2. The optical imaging lens according to claim 1, wherein the optical imaging lens satisfies the following conditions: 1.05≤2ImgH/ODG2≤1.25, where ImgH is the image height of the optical imaging lens.

3. The optical imaging lens according to claim 1, wherein the optical imaging lens satisfies the following conditions: 0.32 mm≤Wmi≤0.48 mm, and 18≤ODG2/Wmi≤45, wherein the mounting portion of the second lens group has an image-side surface, and Wmi is the maximum width of the image-side surface of the mounting portion of the second lens group in the radial direction.

4. The optical imaging lens according to claim 1, wherein the optical imaging lens satisfies the following conditions: 1.07≤ODG2/ODG1≤1.22, wherein the first lens group comprises a plurality of lens elements, wherein the lens element with the maximum outer diameter is the last lens element from the object side to the image side, and ODG1 is the maximum outer diameter of the first lens group.

5. The optical imaging lens according to claim 1, wherein the optical imaging lens further satisfies the following conditions: 16≤ODG2/W2g≤58, where W2g is the maximum width of an adhesion part between the mounting portion of the second lens group and the glue in the radial direction.

6. The optical imaging lens according to claim 1, wherein the optical imaging lens further satisfies the following conditions: 10.7≤ODG2/Wmo≤15.7, where Wmo is the maximum width of an object-side surface of the mounting portion of the second lens group in the radial direction.

7. The optical imaging lens according to claim 1, wherein the optical imaging lens further satisfies the following conditions: 8.3≤TG1/TG2≤10.5, where TG1 is the thickness of the first lens group along the optical axis, and TG2 is the thickness of the second lens group along the optical axis.

8. The optical imaging lens according to claim 1, wherein the optical imaging lens further satisfies the following conditions: 1.02≤ODG2/IDa≤1.14, where IDa is the minimum inner diameter of the adhesive surface.

9. The optical imaging lens according to claim 1, wherein the optical imaging lens further satisfies the following conditions: 18≤ODG2/Wba≤32.

10. The optical imaging lens according to claim 1, wherein the optical imaging lens further satisfies the following conditions: 32≤ODG2/Wba≤60, wherein the optical imaging lens has a fixing ring arranged between the first lens group and the second lens group, and the mounting portion of the second lens group has a protruding mesa, and the protruding mesa is embedded with the rear end of the barrel.

11. The optical imaging lens according to claim 10, wherein the periphery of the protruding mesa has a plurality of recesses extending to the optical axis, Dn is the depth of each recesses, Nn is the number of the recesses, a is the angle of each recesses, and the optical imaging lens further satisfies the following conditions: Dn≤0.05 mm, 6 degrees≤Nn×α≤240 degrees.
